(19) United States
(12) Patent Application Publication
(10) Pub. No.: US 2013/0016463 A1
(43) Pub. Date: Jan. 17, 2013

(54) CONNECTOR APPARATUS

(71) Applicants: Yukio Hiramoto, Kanagawa (JP); Takayoshi Fukiya, Saitama (JP); Asaya Hondo, Chiba (JP)

(72) Inventors: Yukio Hiramoto, Kanagawa (JP); Takayoshi Fukiya, Saitama (JP); Asaya Hondo, Chiba (JP)

(73) Assignee: Sony Corporation, Tokyo (JP)

(21) Appl. No.: 13/540,766

(22) Filed: Jul. 3, 2012

(30) Foreign Application Priority Data
Jul. 15, 2011 (JP) 2011-156632

(51) Int. Cl. H05K 7/14

(52) U.S. Cl. 361/679.01

(57) ABSTRACT

There is provided a connector apparatus including a holder that holds an electronic apparatus having a female connector, and a male connector to be inserted into the female connector to connect thereto when the electronic apparatus is held by the holder.

### BACKGROUND

The present technology relates to a technical field of connector apparatuses. In particular, the present technology relates to a technical field of a connector apparatus which is configured to allow a male connector to rotate with respect to a holder for holding an electronic apparatus, and is provided with a restricting protrusion for restricting rotational movement of the male connector with respect to the holder to prevent the male connector from being deformed when the electronic apparatus is taken out from the holder.

There are known connector apparatuses to which an electronic apparatus such as mobile digital music player or mobile phone is connected.

A connector apparatus as described above has a holder for holding, for example, an electronic apparatus, and is attached to, for example, a dashboard or the like in a vehicle compartment. The connector apparatus is connected to, for example, a processing apparatus (a digital signal processor unit) which outputs data to a car-mounted speaker unit or the like. When the connector apparatus is connected to the processing apparatus, music data or the like are transmitted to the speaker unit via the processing apparatus from the electronic apparatus held by the holder; thus a high quality sound is output from the speaker unit.

The connector apparatus as described above is provided with a male connector to be connected to a female connector included in an electronic apparatus in one end portion thereof in a longitudinal direction; and is provided with holding sections for holding the electronic apparatus, which engage with the electronic apparatus in the other end portion thereof in the longitudinal direction.

When the female connector is connected to the male connector, electrical continuity is established between the electronic apparatus and the connector apparatus. When the female connector is connected to the male connector and a predetermined portion is engaged with the holding section, the electronic apparatus is held by the holder (for example, see JP 2003-134209A).

### SUMMARY

In the connector apparatus as described above, the electronic apparatus may be taken out from the connector apparatus by inclining the electronic apparatus with respect to the connector apparatus on a portion where the female connector is provided to thereby release the electronic apparatus from the holding section.

However, when the electronic apparatus is taken out from the connector apparatus being inclined as described above, since the electronic apparatus is inclined in a state the female connector is being connected to the male connector, accompanying the inclination, a load may be applied to the male connector resulting in a deformation of the male connector.

Particularly, in the case of a connector apparatus used in a vehicle compartment, the connector apparatus is attached to a dashboard or the like being oriented to various direction in the vehicle compartment. Therefore, the electronic apparatus tends to be inclined when the electronic apparatus is taken out from the connector apparatus.

A connector apparatus according to an embodiment of the present technology has been proposed to solve the above problems to prevent the male connector from being deformed when the electronic apparatus is taken out from the holder.

First, in order to solve above problem, a connector apparatus is configured to have a holder that holds an electronic apparatus having a female connector; and a male connector to be inserted into the female connector to connect thereto when the electronic apparatus is held by the holder, wherein the holder includes a base section and a pair of holding projections each protruding in a generally same direction from both ends of the base section, the pair of holding projections engages with the electronic apparatus at both end portions to grip the electronic apparatus, the male connector is rotatably supported by one of the holding projections on an axis which extends in a direction perpendicular to an alignment direction of the pair of holding projections as well as perpendicular to a protruding direction of the holding projections from the base section, a restricting protrusion is formed at a front end portion of the one of the holding projections facing to the male connector in the protruding direction of the holding projection from the base section, wherein, when the engagement of the electronic apparatus with the other holding projection is released in a state the male connector is connected to the female connector and when the male connector is rotated along with the electronic apparatus being inclined with respect to the holder, the electronic apparatus is brought into contact with the restricting protrusion to restrict a rotational movement of the male connector exceeding a predetermined angle.

Therefore, in the connector apparatus, accompanying the inclination of the electronic apparatus with respect to the holder, the male connector is rotated and the electronic apparatus is brought into contact with the restricting protrusion; thereby the rotational movement of the male connector is restricted.

Second, it is preferred to configure the connector apparatus that, in a state where the electronic apparatus with the female connector being connected to the male connector is brought into contact with the restricting protrusion, a front end portion of the restricting protrusion and a front end portion of the male connector exist at generally the same position in the alignment direction.

In the state the electronic apparatus with the female connector connected to the male connector is brought into contact with the restricting protrusion, since the front end portion of the restricting protrusion and the front end portion of the male connector exist at generally the same position in the alignment direction, when the electronic apparatus is inclined with respect to the male connector, the inclination of the electronic apparatus with respect to the male connector is prevented from getting too large.

Third, it is preferred to configure the connector apparatus so that the male connector is rotatable with respect to the holder within a predetermined angle range, the rotation angle of the male connector when the electronic apparatus is brought into contact with the restricting protrusion is adapted to be smaller than a maximum angle within the angle range.

The male connector is configured so as to rotate with respect to the holder within a predetermined angle range, and a rotation angle of the male connector when the electronic apparatus is brought into contact with the restricting protrusion is adapted to be smaller than a maximum angle within the angle range; thereby the rotational movement of the male connector is restricted within a angle smaller than a maximum angle in an angle range by the restricting protrusion.

Fourth, it is preferred to configure the connector apparatus that, in a state before the electronic apparatus is held by the holder, the male connector is inclined toward the restricting protrusion with respect to the alignment direction of the pair of holding projections.

In a state before the electronic apparatus is held by the holder, since the male connector is inclined toward the restricting protrusion with respect to the alignment direction of the pair of holding projections, the male connector is easily inserted into female connector of the electronic apparatus.

Fifth, it is preferred to configure the connector apparatus that, a position of the male connector in a state before the electronic apparatus is held by the holder is set as an initial position, the male connector is configured to be rotatable in an opposite direction with respect to the initial position, and the male connector includes a bias spring for biasing the male connector toward the initial position.

Since the male connector is configured to be rotatable in an opposite direction with respect to the initial position, the male connector includes a bias spring for biasing the male connector toward the initial position, in the state before the electronic apparatus is connected to the connector apparatus, the male connector is constantly held at the initial position at a specific angle with respect to the base section.

Sixth, it is preferred to configure the connector apparatus that the base section of the holder includes an adjuster movable in the protruding direction of the holding projections from the base section, which is configured to be pressed against the electronic apparatus when the electronic apparatus is held by the holder, the holder is capable of holding an electronic apparatus having a different size in the protruding direction of the holding projections from the base section, in the state the electronic apparatus is held by the holder, contact position of the adjuster with respect to the electronic apparatus can be changed in accordance with the size of the held electronic apparatus.

By configuring the holder so that the contact position of the adjuster with respect to the electronic apparatus varies in accordance with the size of the held electronic apparatus in the state the electronic apparatus is held by the holder, even when an electronic apparatus of different size is held by the holder, the position of the electronic apparatus changes little with respect to the holder.

A connector apparatus according to an embodiment of the present technology is configured to have a holder that holds an electronic apparatus having a female connector; and a male connector to be inserted into the female connector to connect thereto when the electronic apparatus is held by the holder, wherein the holder includes a base section and a pair of holding projections each protruding in a generally same direction from both ends of the base section, the pair of holding projections engages with the electronic apparatus at both end portions to grip the electronic apparatus, the male connector is rotatably supported by one of the holding projections on an axis which extends in a direction perpendicular to an alignment direction of the pair of holding projections as well as perpendicular to a protruding direction of the holding projections from the base section, a restricting protrusion is formed at a front end portion of one of the holding projections facing to the male connector in the protruding direction of the holding projection from the base section, wherein, when the engagement of the electronic apparatus with the other holding projection is released in a state the male connector is connected to the female connector and when the male connector is rotated along with the electronic apparatus being inclined with respect to the holder, the electronic apparatus is brought into contact with the restricting protrusion to restrict a rotational movement of the male connector exceeding a predetermined angle.

Therefore, since little load is applied to the male connector from the electronic apparatus, the male connector can be prevented from being deformed while the electronic apparatus is taken out from the connector apparatus.

In a technology of the present disclosure, the connector apparatus is configured so that, when the electronic apparatus with the female connector being connected to the male connector is brought into contact with the restricting protrusion, the front end portion of the restricting protrusion and the front end portion of the male connector exist at generally the same position in the alignment direction.

Therefore, when the electronic apparatus is inclined with respect to the male connector, the inclination of the electronic apparatus with respect to the male connector is prevented from getting too large; thus deformation of the male connector is reduced.

In a technology of the present disclosure, the male connector is rotatable with respect to the holder within a predetermined angle range, the rotation angle of the male connector when the electronic apparatus is brought into contact with the restricting protrusion is adapted to be smaller than a maximum angle within the angle range.

Therefore, breakage or operation failure of a rotation mechanism including the male connector can be prevented.

In a technology of the present disclosure, in a state before the electronic apparatus is held by the holder, the male connector is inclined toward the restricting protrusion with respect to the alignment direction of the pair of holding projections.

Therefore, the male connector is easily inserted into the female connector of the electronic apparatus, satisfactory connection operation and connection state of the female connector with respect to the male connector can be ensured.

In a technology of the present disclosure, defining a position of the male connector in a state before the electronic apparatus is held by the holder as an initial position, the male connector is configured to be rotatable in an opposite direction with respect to the initial position, the male connector includes a bias spring for biasing the male connector toward the initial position.

Therefore, in a state before the electronic apparatus is connected to the connector apparatus, since the male connector is constantly held at the initial position at a specific angle with respect to the base section, connection operation of the electronic apparatus to the connector apparatus is easily made.

In a technology of the present disclosure, the base section of the holder includes an adjuster movable in the protruding direction of the holding projections from the base section, which is configured to be pressed against the electronic apparatus when the electronic apparatus is held by the holder, the holder is capable of holding an electronic apparatus having a different size as viewed in the protruding direction of the holding projections from the base section, in the state the electronic apparatus is held by the holder, contact position of the adjuster with respect to the electronic apparatus can be changed in accordance with the size of the held electronic apparatus.

Therefore, even when an electronic apparatus having largely different size in the protruding direction of the holding projection is connected to the connector apparatus, the position of the electronic apparatus with respect to the holder changes little. Accordingly, regardless of the difference in size, connection operation and taking-out operation of the electronic apparatus with respect to the connector apparatus can be made properly.

### BRIEF DESCRIPTION OF THE DRAWINGS

FIG. 1 illustrates a connector apparatus according to an embodiment of the present technology along with FIG. 2 to FIG. 20; FIG. 1 is a perspective illustration showing a connector apparatus and electronic apparatuses to be connected to the connector apparatus, only the thickness thereof is different from each other;

FIG. 2 is a perspective illustration showing the connector apparatus in which a stand and a holder are separated from each other;

FIG. 3 is an exploded perspective illustration showing component parts of the connector apparatus;

FIG. 4 is a side view of the connector apparatus;

FIG. 5 is a side view of the connector apparatus as viewed from the opposite side thereof in FIG. 4;

FIG. 6 is a front view of the connector apparatus;

FIG. 7 is a block diagram illustrating a connection state among the connector apparatus and other units;

FIG. 8 illustrates a connection operation of an electronic apparatus to the connector apparatus along with FIG. 9 to FIG. 15; FIG. 8 is a side view showing a state before the electronic apparatus is connected to the connector apparatus;

FIG. 9 is a side view showing a state a female connector of the electronic apparatus is connected to a male connector;

FIG. 10 is a side view showing a state in which the electronic apparatus is pressed backward parallel to a base section;

FIG. 11 is a side view showing a state in which the electronic apparatus is held by a holder and is connected to the connector apparatus;

FIG. 12 is a front view showing a state in which the electronic apparatus is held by a holder and is connected to the connector apparatus;

FIG. 13 is an enlarged cross-sectional view showing a state in which the electronic apparatus is held by the holder and is connected to the connector apparatus;

FIG. 14 is a side view showing a state in which the electronic apparatus is inclined forward when the electronic apparatus is dismounted from the connector apparatus;

FIG. 15 is an enlarged cross-sectional view showing a state in which the electronic apparatus is brought into contact with a restricting protrusion and rotational movement of the male connector is restricted;

FIG. 16 is a side view illustrating a state in which an electronic apparatus having a larger thickness is held by the holder and is connected to the connector apparatus;

FIG. 17 is a side view illustrating a state in which an electronic apparatus having a smaller thickness is held by the holder and is connected to the connector apparatus;

FIG. 18 is an enlarged cross-sectional view showing a state in which the electronic apparatus having a smaller thickness is brought into contact with the restricting protrusion and rotational movement of the male connector is restricted;

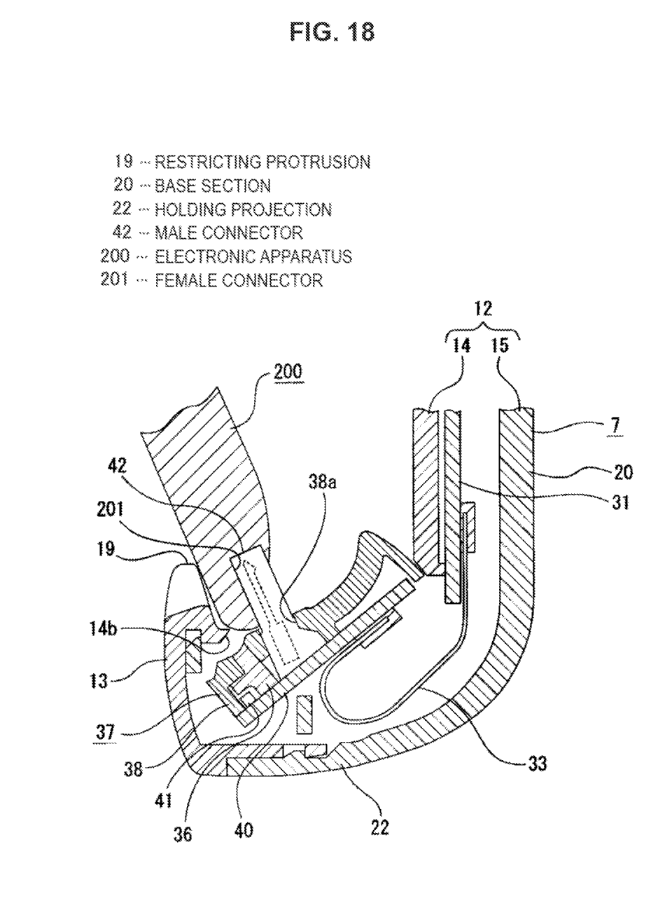

FIG. 19 illustrates a positional relationship (height) between the restricting protrusion and the male connector along with FIG. 20; and FIG. 19 is a conceptual illustration showing a case where the height of the restricting protrusion is smaller with respect to the height of the male connector; and

FIG. 20 is a conceptual illustration showing a case where the height of the restricting protrusion is larger with respect to the height of the male connector.

### DETAILED DESCRIPTION OF THE EMBODIMENT(S)

Preferred embodiments of a connector apparatus according to the present technology will be described below with reference to the appended drawings.

A preferred embodiment of a connector apparatus of the present technology described below is a one which is applied to a connector apparatus connected to a processing apparatus for outputting data to a car-mounted speaker unit used in a vehicle compartment.

Applicable range of the present technology is not limited to a connector apparatus which is connected to a processing apparatus for outputting data to a car-mounted speaker unit. The connector apparatus according to an embodiment of the present technology is widely applicable to various kinds of connector apparatuses each of which has a male connector to be connected to a female connector of an electronic apparatus and holds an electronic apparatus in a state the male connector is connected to the female connector. Particularly, the connector apparatus is suitably applicable to a connector apparatus so-called a cradle to which a mobile phone or a mobile digital music player (DMP) is connected.

### [Schematic Configuration of Electronic Apparatus]

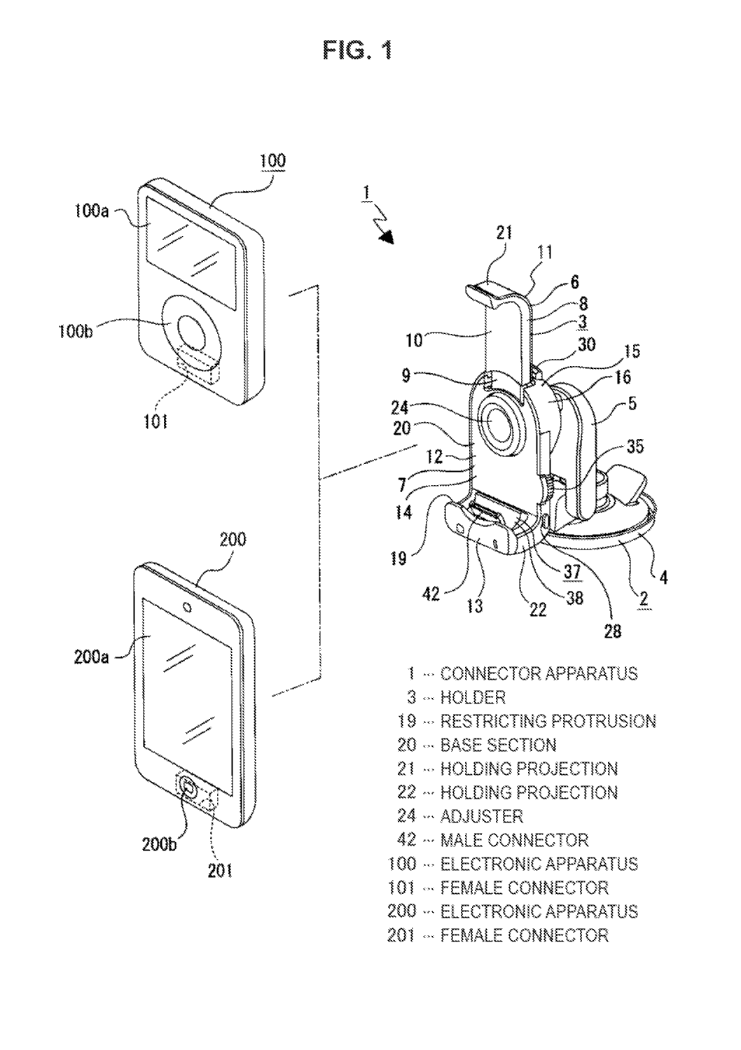

An electronic apparatus which is connected to the connector apparatus will be described first (refer to FIG. 1).

The connector apparatus is arranged to be selectively connectable with an electronic apparatus 100 or an electronic apparatus 200 each having a different thickness.

The electronic apparatus 100 is, for example, a mobile DMP having a generally rectangular shape, which is flat and vertically long. The electronic apparatus 100 has a display plane 100a and an operation part 100b on the front surface thereof. The display plane 100a also functions as, for example, a touch panel. By operating the display plane 100a or the operation part 100b, a predetermined processing of such as outputting stored music data or the like to the outside or selection of music data can be made.

The electronic apparatus 100 is provided with a female connector 101 which is opened downward in a bottom end portion thereof.

The electronic apparatus 200 is, for example, a mobile DMP having a generally rectangular shape, which is flat and vertically long. The thickness of the electronic apparatus 200 is, for example, is thinner than the thickness of the electronic apparatus 100.

The electronic apparatus 200 has a display plane 200a and an operation part 200b on the front surface thereof. The display plane 200a also functions as, for example, a touch panel. By operating the display plane 200a or the operation part 200b, a predetermined processing of such as outputting stored music data or the like to the outside or selection of music data can be made.

The electronic apparatus 200 is provided with a female connector 201 which is opened downward in a bottom end portion thereof.

### [Structure of Connector Apparatus]

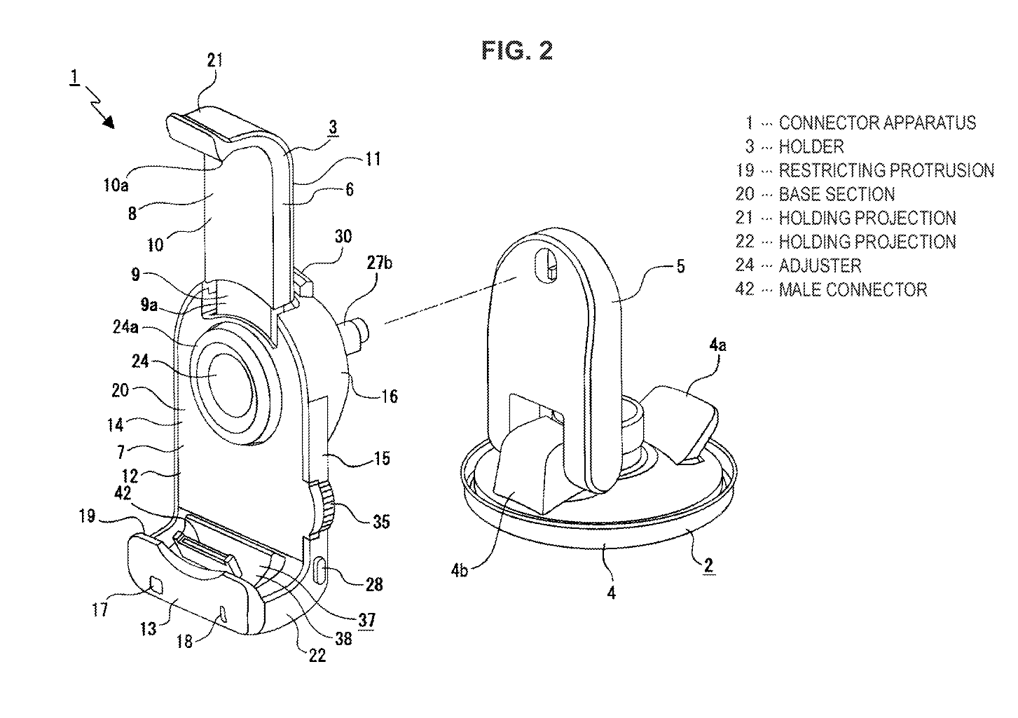

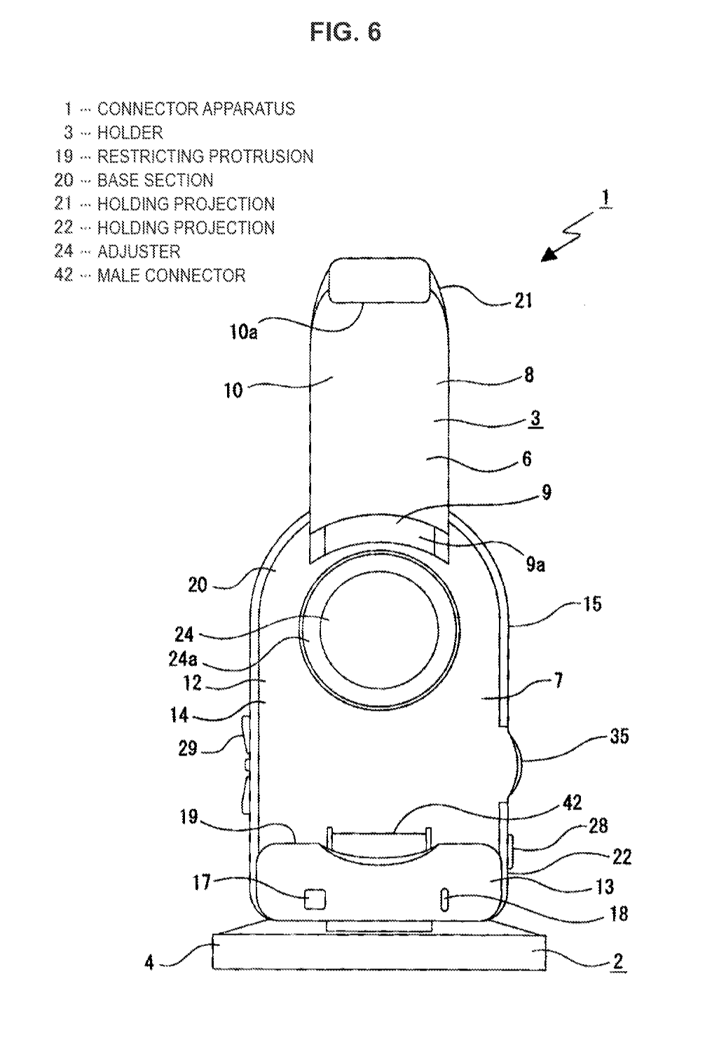

Subsequently, the connector apparatus will be described (refer to FIG. 1 to FIG. 6).

The connector apparatus 1 includes a stand 2 and a holder 3.

The stand 2 has a mounting member 4 and a support leg 5 rotatably connected to the mounting member 4. The mounting member 4 is formed in a generally disk like shape which faces in a vertical direction, and has a suction cup at the bottom face side thereof (not shown). The mounting member 4 is provided with a suction operation part 4a. The mounting member 4 is provided with a support projection 4b protruding upward.

When the suction operation part 4a is operated, for example, the mounting member 4 is caused to suck to an attachment plane such as a dashboard of a vehicle by the suction cup; or the suction is released from the attachment plane.

The support leg 5 is configured to be rotatably connected to the support projection 4b of the mounting member 4. When the support leg 5 is moved to rotate, the upper end portion thereof moves in a generally front and rear direction. Also, the support leg 5 is configured to rotate along with a rotation of a part of the mounting member 4 in a circumferential direction.

The holder 3 has an upper chassis 6 and a lower chassis 7 vertically coupled with each other, which are configured so that the upper chassis 6 is movable in a vertical direction with respect to the lower chassis 7.

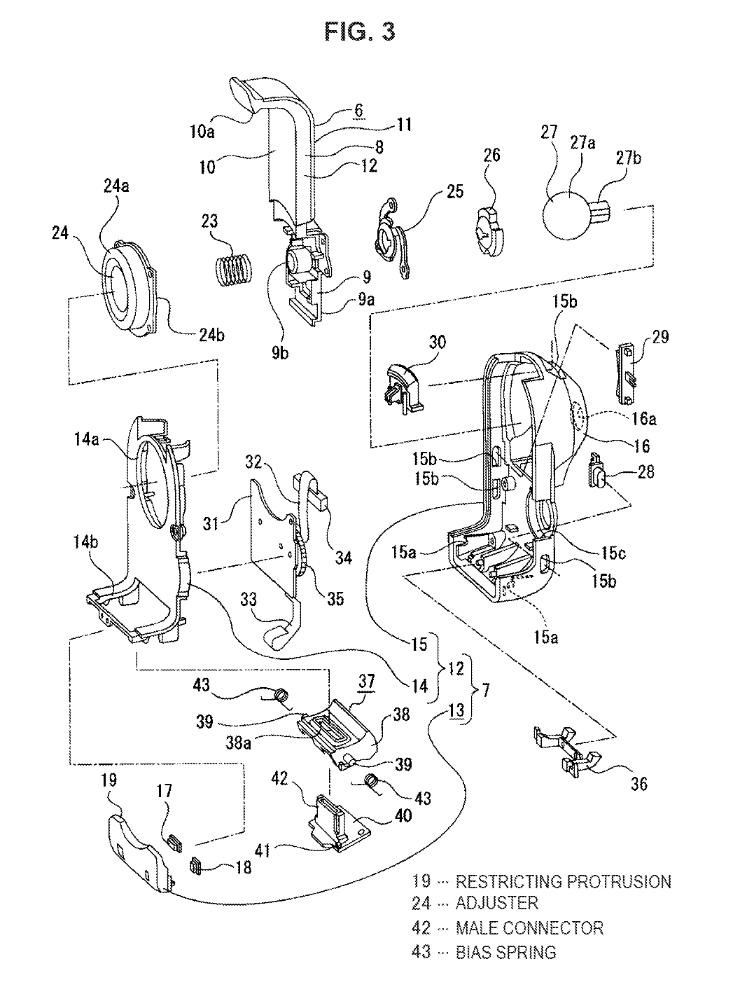

The upper chassis 6 includes a frame part 8 and an inner structure portion 9 positioned at a lower part of the frame part 8 (refer to FIG. 3). The frame part 8 is configured to be movable in a vertical direction with respect to the inner structure portion 9.

The frame part 8 includes a front cabinet 10 and a rear panel 11 which are combined to each other at the front side and the rear side thereof.

The front cabinet 10 is formed in a vertically long shape. A part excluding an upper end portion of the front cabinet 10 is formed to open backward; and a part of the upper end portion excluding a front end portion is formed to open upward and backward. The front cabinet 10 is formed so that the upper end portion protrudes forward than the other portion thereof. The front cabinet 10 is provided with a positional restricting protrusion 10a protruding downward from the front end portion.

The rear panel 11 is formed in a vertically long shape, and an upper end portion thereof is formed to protrude forward than the other portion thereof.

The inner structure portion 9 includes a base plate portion 9a formed in a plate-like shape oriented in a generally front and rear direction, and a spring support projection 9b protruding forward from the base plate portion 9a.

The lower chassis 7 includes a frame part 12 and a panel portion 13 attached to the frame part 12.

The frame part 12 includes a front panel 14 and a rear cabinet 15 which are combined to each other at the rear side and the front side thereof.

The front panel 14 is formed in a vertically long shape. The front panel 14 includes a support hole 14a which goes through in a front and rear direction in an upper end portion thereof, and a disposition hole 14b which goes through in a vertical direction in a lower portion thereof. The front panel 14 is formed so that the lower portion protrudes forward than the other portion thereof.

The rear cabinet 15 is formed in a vertically long shape. A portion of the rear cabinet 15 excluding a lower portion is formed to open forward, and the lower portion thereof is formed to open obliquely upward. The rear cabinet 15 is formed so that a lower portion protrudes forward than the other portion thereof. The rear cabinet 15 includes a protruding disposition portion 16 protruding backward in an upper end portion thereof. And the protruding disposition portion 16 includes a shaft insertion hole 16a which goes through in front and rear direction in a rear end portion thereof.

The rear cabinet 15 includes a pair of bearing concave portions 15a, 15a each formed on the inner side face of the right and left side walls in a lower portion of the rear cabinet 15.

The rear cabinet 15 is formed with a plural button disposition holes 15b, 15b, . . . and a knob disposition opening 15c in a predetermined position respectively.

The panel portion 13 is attached to the frame part 12, which is formed by the front panel 14 and the rear cabinet combined to each other, from the front side in a lower portion thereof. The panel portion 13 is formed with a transparent hole 13a and a disposition hole 13b being separated from each other. The panel portion 13 includes an infrared filter 17 attached to the transparent hole 13a and an indicator 18 attached to the disposition hole 13b.

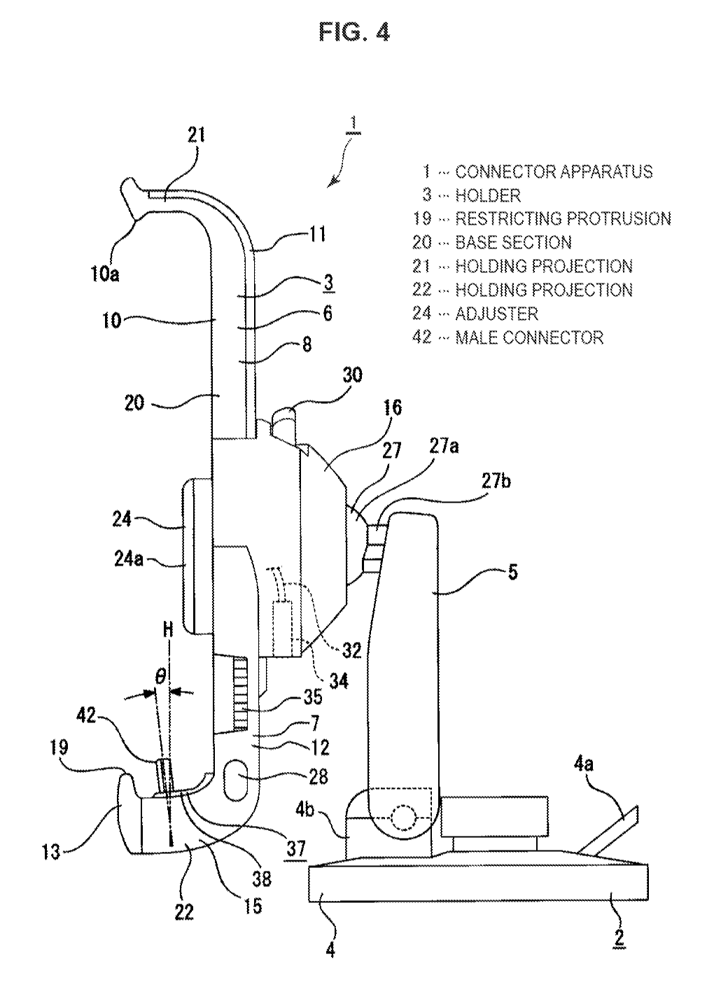

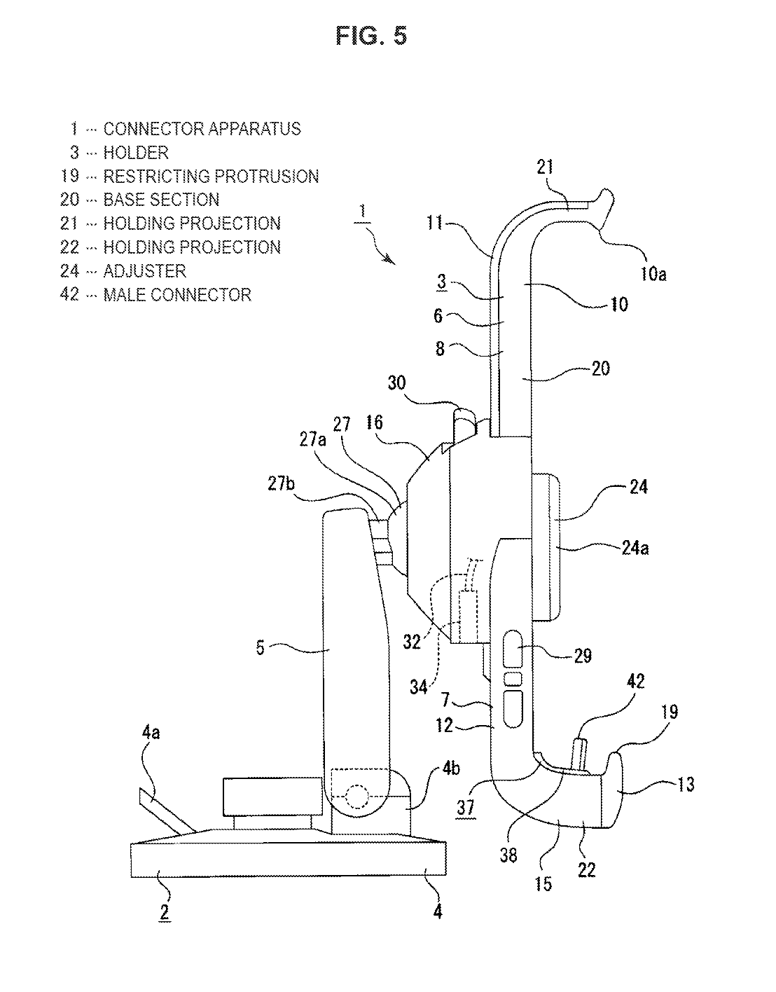

In a state the panel portion 13 is attached to the frame part 12, an upper end portion of the panel portion 13 protrudes upward higher than the upper face of a lower portion of the frame part 12 (refer to FIG. 4 and FIG. 5), the protruding portion forms a restricting protrusion 19.

The holder 3 is formed by the lower chassis 7 and the upper chassis 6 combined to each other and the panel portion 13 attached to the lower chassis 7. The holder 3 includes the base section 20 oriented in a generally front and rear direction, which is formed by a portion of the frame part 8 excluding the upper end portion and a portion of the frame part 12 excluding a lower portion thereof. The upper end portion and the lower portion of the holder 3 include holding projections 21 and 22 each protruding forward from the base section 20.

The upper chassis 6 is provided with a compression coil spring 23 disposed inside of the lower end portion so as to compress and expand in a front and rear direction (refer to FIG. 3). The compression coil spring 23 is supported by a spring support projection 9b provided to the inner structure portion 9 of the upper chassis 6.

The lower chassis 7 includes an adjuster 24 disposed in an upper end portion inside of the frame part 12. The adjuster 24 includes a pushing portion 24a formed in a generally cylindrical shape and a flange portion 24b extending outward from a rear end portion of the pushing portion 24a. The adjuster 24 is supported with the pushing portion 24a inserted through the support hole 14a of the front panel 14, and the adjuster 24 is being applied with a force forward by the compression coil spring 23.

Inside of the protruding disposition portion 16 formed on the frame part 12 of the lower chassis 7, a press spring 25 and a receiving member 26 are provided being disposed in order from the front side. The press spring 25 is disposed behind the inner structure portion 9 of the upper chassis 6 in a state that the front surface thereof is in contact with the base plate portion 9a of the inner structure portion 9.

Behind the receiving member 26, a support member 27 is disposed. The support member 27 includes a glove portion 27a formed in a glove shape and a connection shaft portion 27b protruding backward from the glove portion 27a. The glove portion 27a of the support member 27 is disposed inside the protruding disposition portion 16; and the connection shaft portion 27b protrudes backward through the shaft insertion hole 16a formed in the rear cabinet 15 of the lower chassis 7.

The receiving member 26 is pressed to the glove portion 27a of the support member 27 from the front side by the press spring 25 to generate a constant frictional force between the glove portion 27a and the receiving member 26. The receiving member 26 is held on the glove portion 27a of the support member 27 so as to rotate in an arbitrary direction.

The connection shaft portion 27b of the support member 27 is connected to the upper end portion of the support leg 5 of the stand 2. In a state that the connection shaft portion 27b of the support member 27 is connected to the support leg 5, the receiving member 26 in the holder 3 is allowed to slide on the glove portion 27a of the support member 27 so as to rotate in an arbitrarily direction, and is held at an arbitrarily rotational position by the frictional force generated between the glove portion 27a and the receiving member 26 by a applied force by the press spring 25.

The frame part 12 of the lower chassis 7 is provided with operation buttons 28, 29 and 30. The operation buttons 28, 29 and 30 are disposed in the button disposition holes 15b and 15b, . . . to allow a user to operate from the outside. Each of the operation buttons 28, 29 and 30 functions as, for example, a power button, a button for fast-forwarding/rewinding of music data stored in the electronic apparatus 100, a button for allowing or restricting the upper chassis 6 to move with respect to the lower chassis 7 respectively.

Inside the frame part 12 of the lower chassis 7, a circuit board 31 is disposed being oriented in a front and rear direction in a lower portion of the protruding disposition portion 16. The circuit board 31 is connected to flexible printed wiring boards 32 and 33 at the upper and lower end portions thereof. The upper flexible printed wiring board 32 is connected to a connector 34. The connector 34 is attached to the inner face of the rear cabinet 15 of the frame part 12.

The circuit board 31 is provided with a rotatable dial knob 35; and the dial knob 35 is disposed in the knob disposition opening 15c of the frame part 12. Therefore, the dial knob 35 is operable from the outside. The dial knob 35 functions as a knob for adjusting volume of the music data.

A light guide member 36 is attached to the frame part 12 of the lower chassis 7 in a lower portion thereinside.

In a lower portion inside of the frame part 12 of the lower chassis 7, a rotatable member 37 is rotatably supported. The rotatable member 37 includes a main body 38 and a pair of shafts 39, 39 each extending rightward/leftward from the main body 38, and the main body 38 is formed with a connector insertion hole 38a.

The rotatable member 37 is supported by the shafts 39, 39 engaged with bearing concave portions 15a, 15a each formed on an inner surface of the rear cabinet 15. Therefore, the rotatable member 37 is supported so as to rotate on the shafts 39, 39 each extending rightward and leftward.

To a bottom face of the main body 38 of the rotatable member 37, a connection board 40 is attached. The connection board 40 includes a semiconductor light emitting element 41 mounted thereon. The connection board 40 is connected to the flexible printed wiring board 33 which is connected to the circuit board 31.

The connection board 40 includes a male connector 42 mounted thereon. In a state the connection board 40 is mounted on the main body 38, the male connector 42 is inserted through the connector insertion hole 38a from the bottom thereof, and a part of the male connector 42 protrudes upward from the main body 38.

The rotatable member 37 mounted with the connection board 40 is disposed in the disposition hole 14b formed in the front panel 14 of the frame part 12. Therefore, the male connector 42 is rotated along with the rotatable member 37 and the connection board 40 which are disposed in the disposition hole 14b.

In the state the rotatable member 37 is supported by the frame part 12, and bias springs 43 and 43 are supported by the shafts 39, 39 respectively. The bias springs 43 and 43 are made of, for example, a torsion coil spring, and has a function to bias the male connector 42 via the rotatable member 37. The male connector 42 is adapted to rotate in an opposite direction with respect to an initial position. The initial position is a position inclined forward by 0° with respect to a direction H which is an extending direction of the base section 20 of the holder 3; for example, a position inclined forward by 6° (refer to FIG. 4). The male connector 42 is biased by the bias springs 43 and 43 via the rotatable member 37 in a direction to return to the initial position.

The male connector 42 is rotated from the initial position. The male connector 42 is adapted so as, for example, to rotate up to a state being inclined forward by 25° with respect to the extending direction H, and to rotate backward up to the extending direction H; i.e. to 0°. Therefore, the male connector 42 rotated from the initial position as the start point, and when a force given in the rotation direction is released, the male connector 42 is returned at all times to the initial position (state of inclination of 6°)by the bias given by the bias springs 43 and 43.

When a light is emitted from the semiconductor light emitting element 41 mounted on the connection board 40, the emitted light is guided through the light guide member 36 and enters into the indicator 18 attached to the panel portion 13. The semiconductor light emitting element 41 is capable of emitting light of different color, and the indicator 18 is colored depending on the emitted color. A user can recognize the operation state of the connector apparatus 1 by viewing the color of the indicator 18.

When a remote controller described below is operated, infrared light emitted from the remote controller enters into a light receiving section (not shown) via the infrared filter 17, and the connector apparatus 1 is made to be remote-controlled through the remote controller.

### [Connection State of Connector Apparatus]

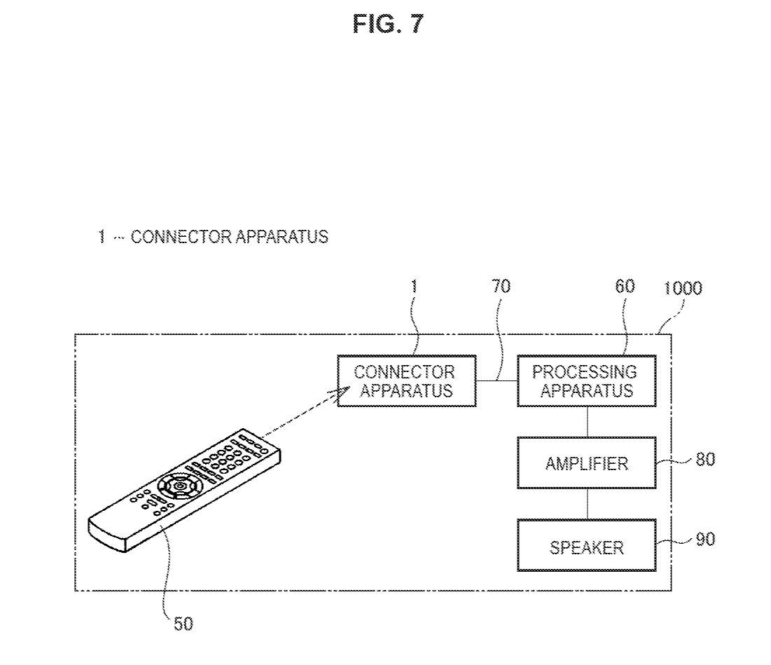

Now, connection state of the connector apparatus 1 with other units will be described below (refer to FIG. 7).

The connector apparatus 1 which is configured as described above is used on, for example, a vehicle 1000. In a vehicle compartment of the vehicle 1000, the connector apparatus 1 is attached to, for example, a dashboard; and is operated manually or through a remote controller 50.

The connector apparatus 1 is connected to, for example, a processing apparatus (digital signal processor unit) 60 which outputs data to a car-mounted speaker unit. A cable 70 connects between the connector apparatus 1 and the processing apparatus 60 via the connector 34 of the connector apparatus 1 and a connection terminal of the processing apparatus 60.

The processing apparatus 60 is connected to a speaker 90 which functions as a sound output unit through an amplifier 80 which functions as an amplifying circuit. A predetermined processing is made to control the amplifier 80 and the speaker 90.

The voice data, which are output from the connector apparatus 1, is sent to the processing apparatus 60; output from the processing apparatus 60; after being amplified by the amplifier 80, output from the speaker 90 as a high quality sound.

### [Connection Operation of Electronic Apparatus to Connector Apparatus]

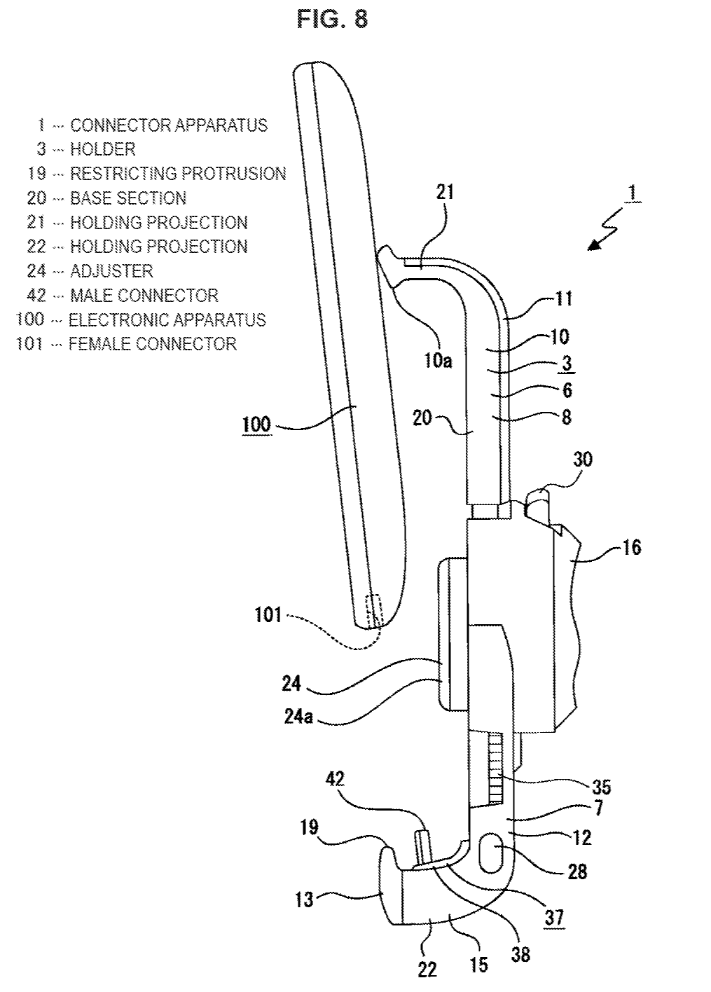

The connection operation of the electronic apparatus 100 to the connector apparatus 1 will be described below (refer to FIG. 8 to FIG. 15).

In a state before the electronic apparatus 100 is connected, the male connector 42 is positioned at the initial position being inclined forward by, for example, 6° with respect to the extending direction of the base section 20 of the holder 3; i.e. toward the restricting protrusion 19 (refer to FIG. 8). At this time, the upper chassis 6 is slid upward with respect to the lower chassis 7 and is positioned at an upper shift end.

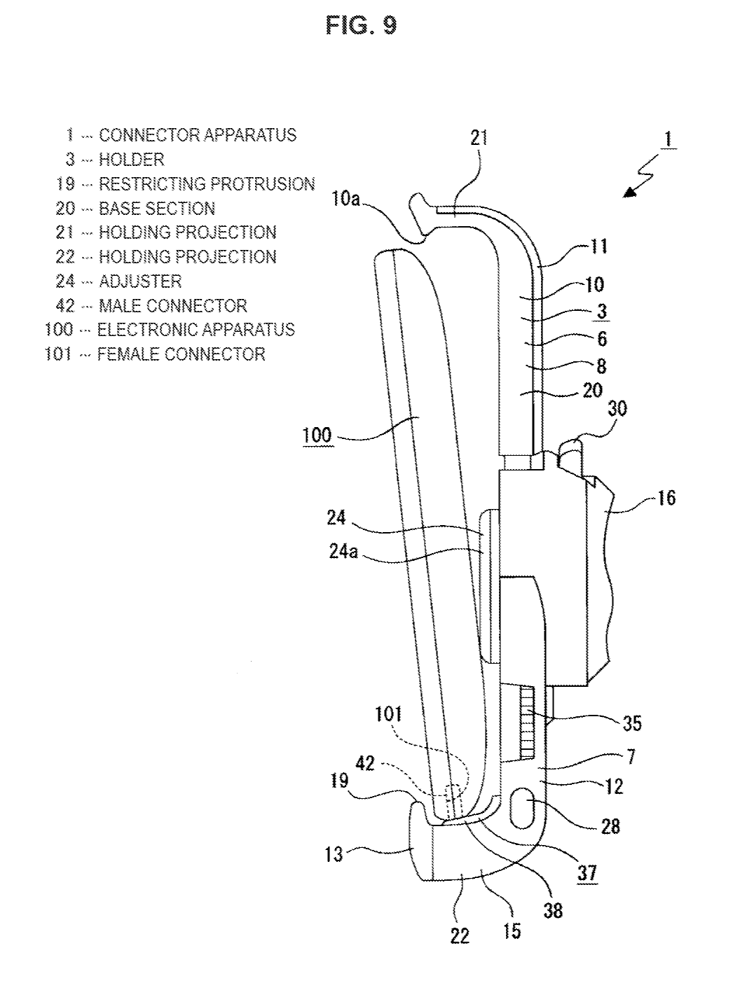

While avoiding interference with the upper holding projection 21, the electronic apparatus 100 is moved downward along the base section 20 of the holder 3 from an upper position in a state being slightly inclined forward, and the female connector 101 is connected to the male connector 42 (refer to FIG. 9).

At this time, since the male connector 42 is inclined toward the restricting protrusion 19, the male connector 42 is easily inserted into the female connector 101 of the electronic apparatus 100, satisfactory connection operation and connection state of the female connector 101 to the male connector 42 can be ensured.

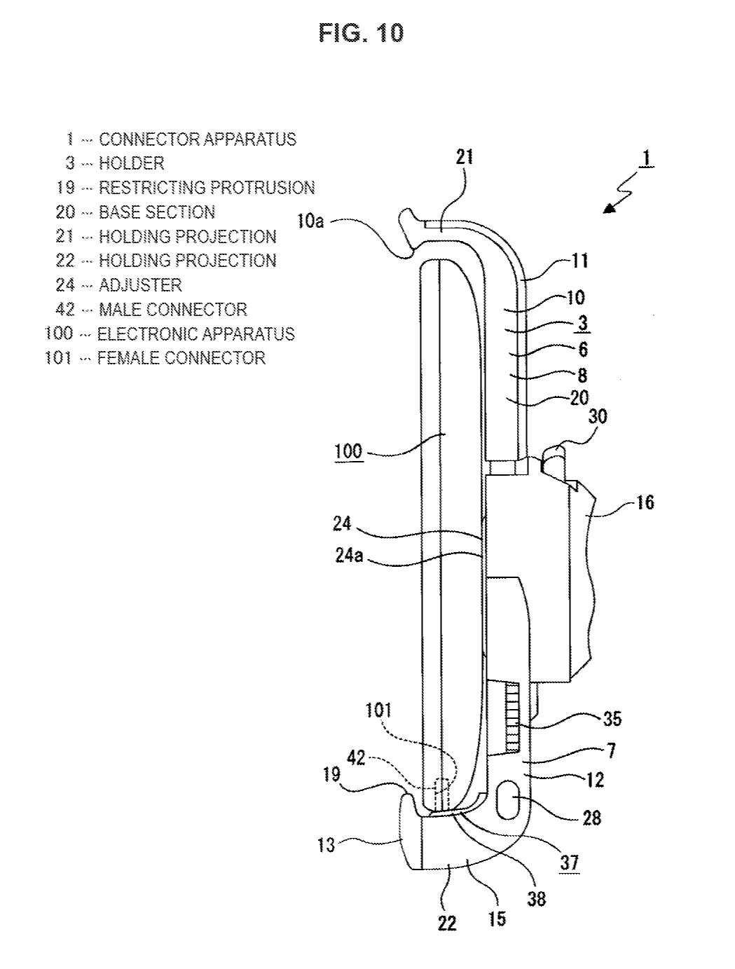

Then, the electronic apparatus 100 is pushed backward to bring the electronic apparatus 100 in a state parallel to the base section 20 (refer to FIG. 10). At this time, the adjuster 24 is pressed by the electronic apparatus 100, and the adjuster 24 is moved backward against a force given by the compression coil spring 23; and the pushing portion 24a is brought into a close contact with the rear face of the electronic apparatus 100 due to a force given by the compression coil spring 23.

When the electronic apparatus 100 is pushed backward, the electronic apparatus 100 is rotated on the lower portion thereof. At this time, the male connector 42 rotates along with the rotatable member 37 and the connection board 40. Since the male connector 42 is configured to be rotated, when the electronic apparatus 100 is pushed backward, little load is applied to the male connector 42. Thus, the male connector 42 is prevented from being deformed when the electronic apparatus 100 is pushed backward.

In the state the electronic apparatus 100 is made parallel to the base section 20, the male connector 42 is rotated up to the same angle of the direction H in which the base section 20 extends (0°).

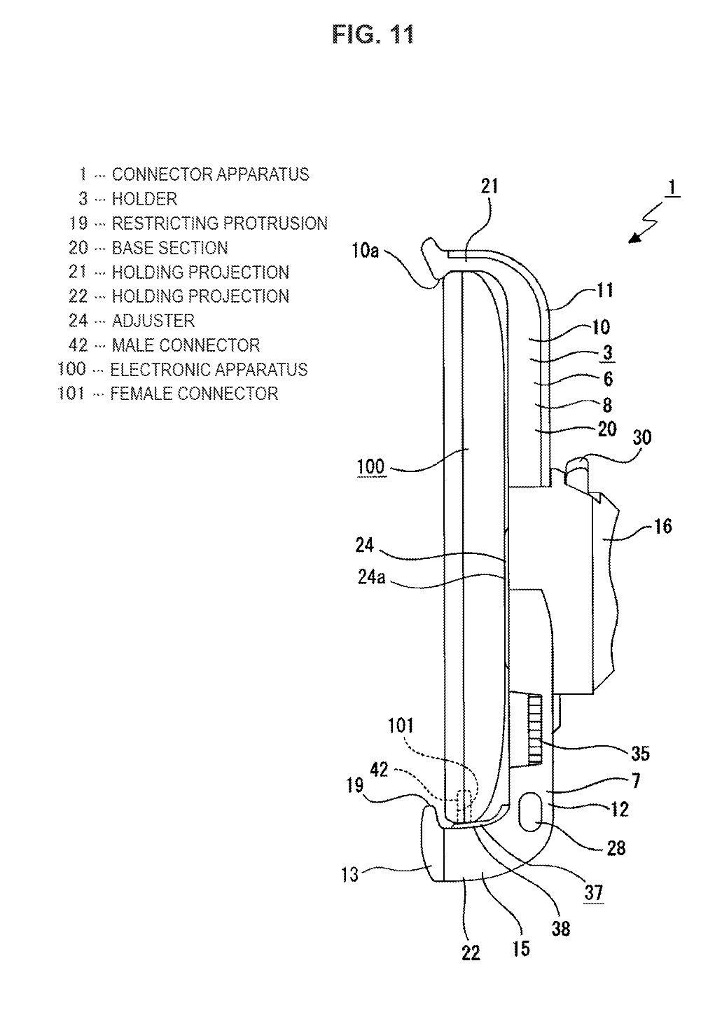

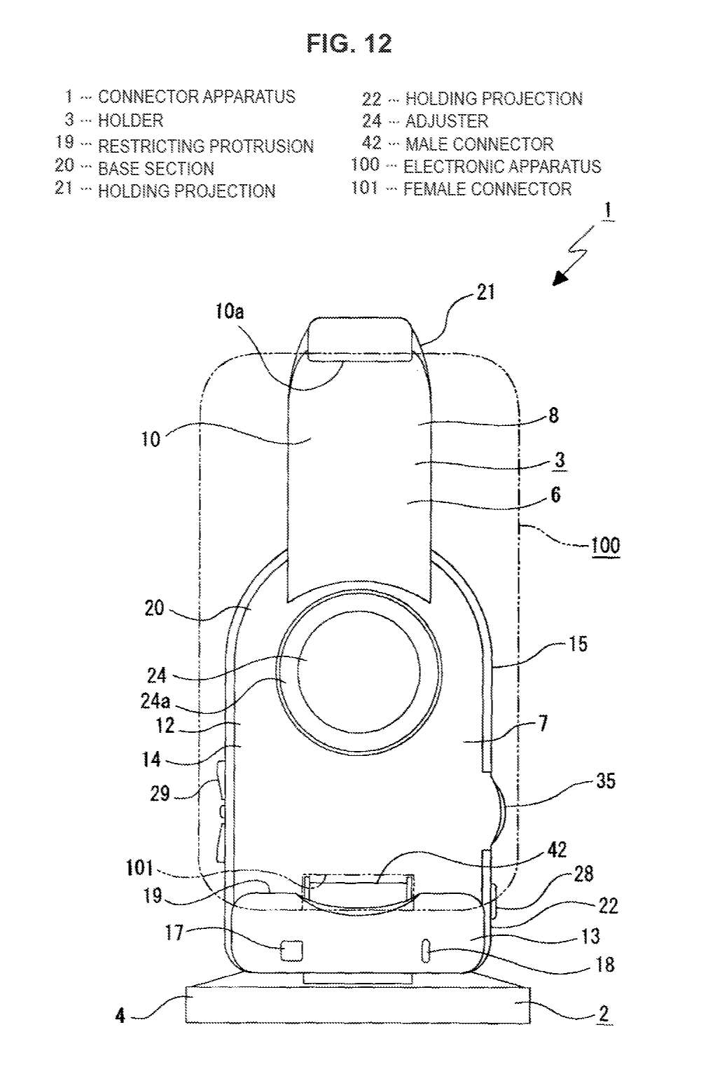

Then, the upper chassis 6 is moved downward with respect to the lower chassis 7 (refer to FIG. 11 and FIG. 12). When the upper chassis 6 is moved downward, the front edge at the upper end portion of the electronic apparatus 100 is engaged with the position restricting protrusion 10a formed at the front end portion of the holding projection 21 of the upper chassis 6. Thus, the electronic apparatus 100 is held by the holder 3. At this time, since a force is given to the electronic apparatus 100 by the compression coil spring 23 via the adjuster 24, the front edge at the upper end portion of the electronic apparatus 100 is pressed to the position restricting protrusion 10a; thus the state the electronic apparatus 100 engaged with the position restricting protrusion 10a is kept.

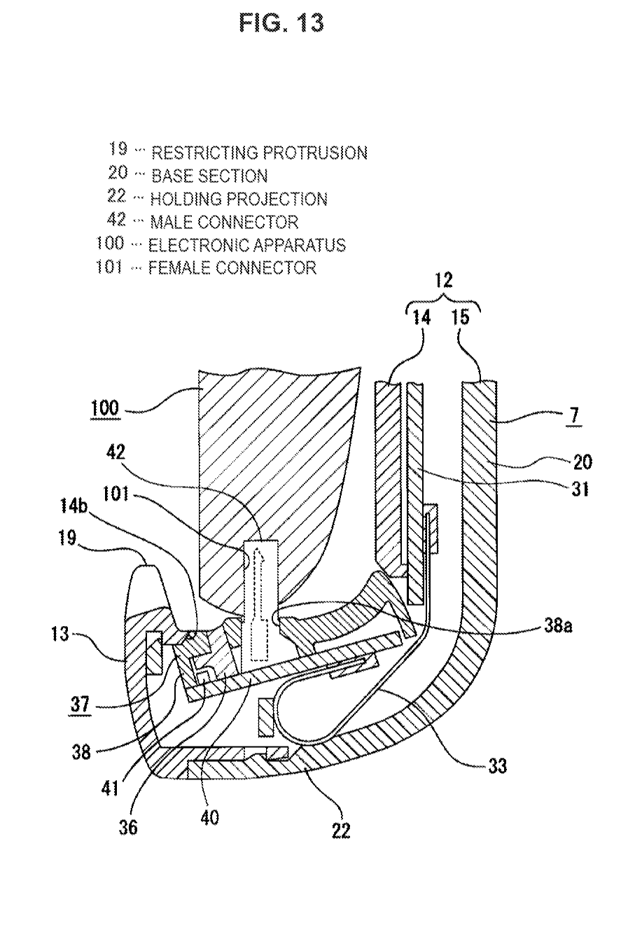

In the state the electronic apparatus 100 is held by the holder 3, the electronic apparatus 100 is held in a state parallel to the base section 20, and the state the male connector 42 is held at the same angle of the direction H in which the base section 20 extends (0°) (refer to FIG. 11 and FIG. 13). In the state the electronic apparatus 100 is held by the holder 3, music data stored in the electronic apparatus 100 are output to the processing apparatus 60.

When the electronic apparatus 100 is taken out from the connector apparatus 1, the upper chassis 6 is slid upward with respect to the lower chassis 7 first. When the upper chassis 6 is moved upward, the engagement between the front edge at the upper end portion of the electronic apparatus 100 and the position restricting protrusion 10a formed at the front end portion of the holding projection 21 on the upper chassis 6 is released, and the adjuster 24 is moved forward due to the force given by the compression coil spring 23; thus, the electronic apparatus 100 is pressed forward by the adjuster 24.

When the electronic apparatus 100 is pressed forward by the adjuster 24, the electronic apparatus 100 is rotated on the lower portion thereof and is caused to incline forward. At this time, the male connector 42 is rotated along with the rotatable member 37 and the connection board 40. Since the male connector 42 is configured to be rotated as described above, when the electronic apparatus 100 is pushed forward, little load is applied to the male connector 42. The male connector 42 is prevented from being deformed when the electronic apparatus 100 is pushed forward.

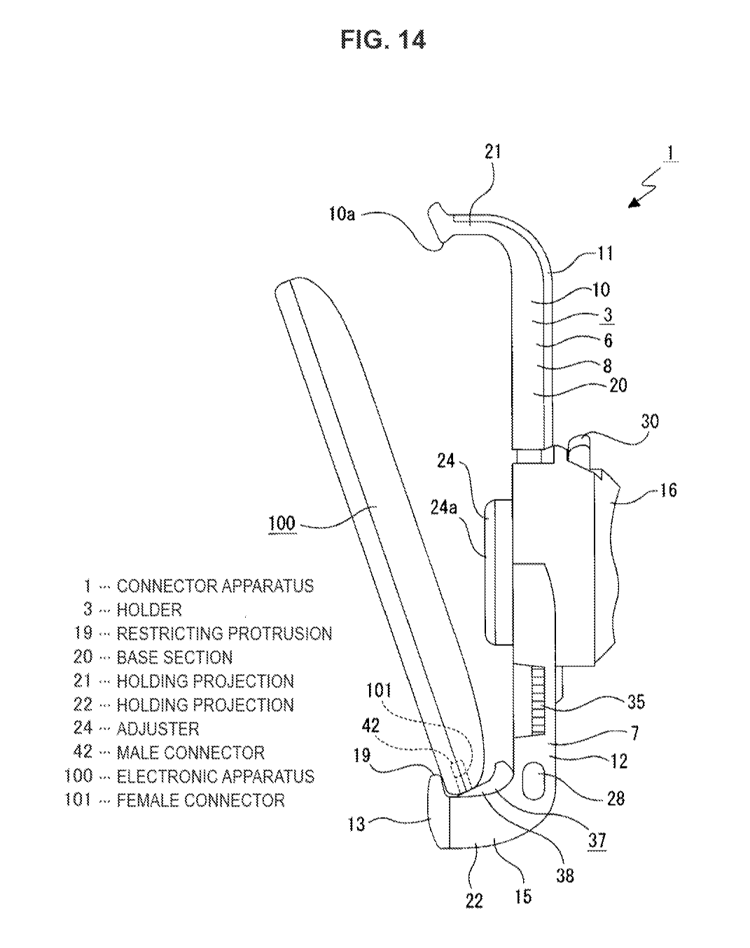

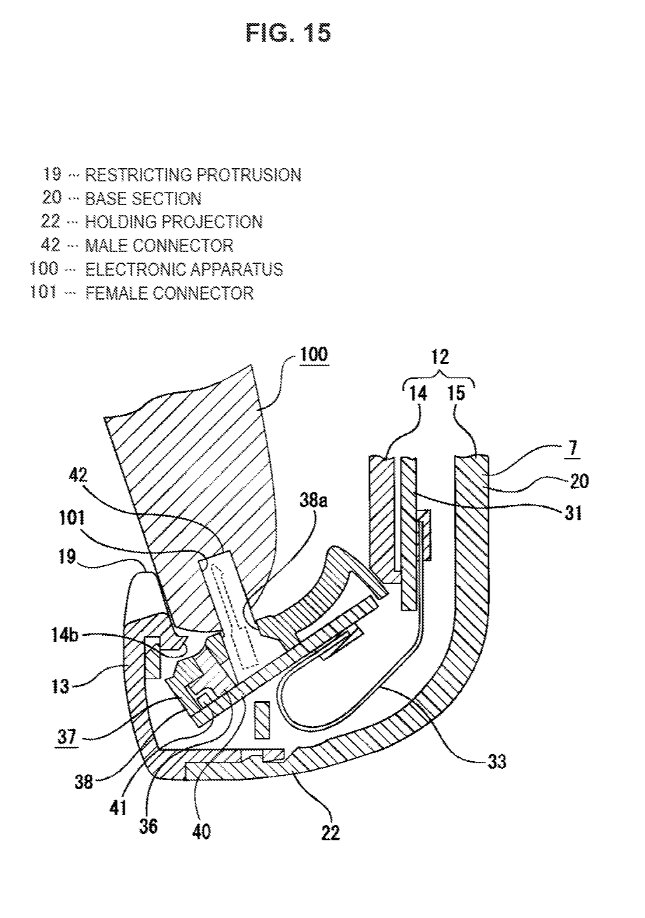

Subsequently, the electronic apparatus 100 is further inclined forward being held by a hand (refer to FIG. 14 and FIG. 15). Even when the electronic apparatus 100 is further inclined forward, the male connector 42 is rotated along with the rotatable member 37 and the connection board 40.

The electronic apparatus 100 can be inclined forward until the front surface thereof at the lower portion is brought into contact with the restricting protrusion 19. When the front surface at the lower portion of the electronic apparatus 100 is brought into contact with the restricting protrusion 19, the forward inclination of the electronic apparatus 100 is restricted.

As described above, the maximum rotatable angle of the male connector 42 at the initial position is adapted to 25° with respect to the extending direction H of the base section 20. However, in a state the forward inclination of the electronic apparatus 100 is restricted by the restricting protrusion 19, the rotation angle of the male connector 42 with respect to the initial position is adapted to be smaller than the maximum angle; for example, to 19°.

Thus, in the connector apparatus 1, in the state that the electronic apparatus 100 is brought into contact with the restricting protrusion 19 and the forward inclination is restricted, the rotation angle of the male connector 42 is adapted to be smaller than the rotatable maximum angle of the male connector 42.

Therefore, breakage or operation failure of the rotation mechanism including the rotatable member 37 and the male connector 42 can be prevented.

Then, when the electronic apparatus 100 is pulled obliquely upward at an angle, the connection between the female connector 101 and the male connector 42 is released; and thus the electronic apparatus 100 is taken out from the connector apparatus 1.

When the electronic apparatus 100 is taken out from the connector apparatus 1, the male connector 42 returns to the initial position due to a bias given by the bias springs 43 and 43 (refer to FIG. 8).

As described above, in the connector apparatus 1, the male connector 42 is configured to be rotatable in an opposite direction with respect to the initial position, and bias springs 43 and 43 biases the male connector 42 toward the initial position.

Therefore, in the state before the electronic apparatus 100 is connected to the connector apparatus 1, since the male connector 42 is constantly held at the initial position at a specific angle with respect to the base section 20, the connection operation of the electronic apparatus 100 to the connector apparatus 1 can be easily carried out.

The connection operation of the electronic apparatus 100 to the connector apparatus 1 and the take-out operation of the electronic apparatus 100 from the connector apparatus 1 have been described above. However, as described above, the connector apparatus 1 is configured to be connectable to an electronic apparatus 200 which has a thickness different from the electronic apparatus 100. The thickness of the electronic apparatus 200 is smaller than the thickness of, for example, the electronic apparatus 100.

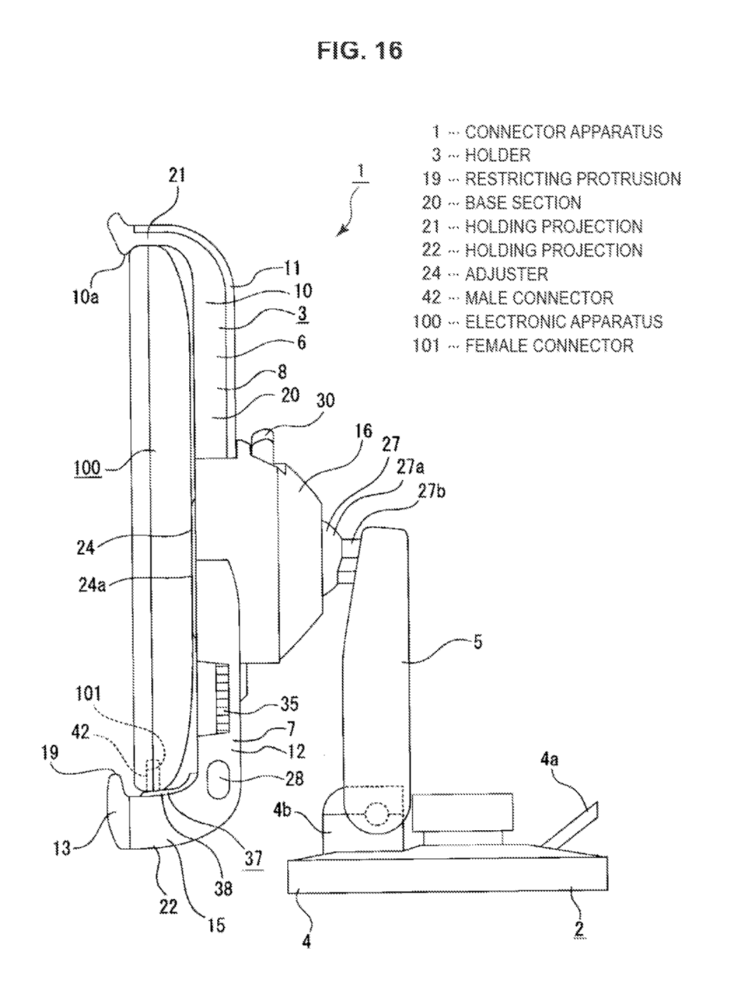

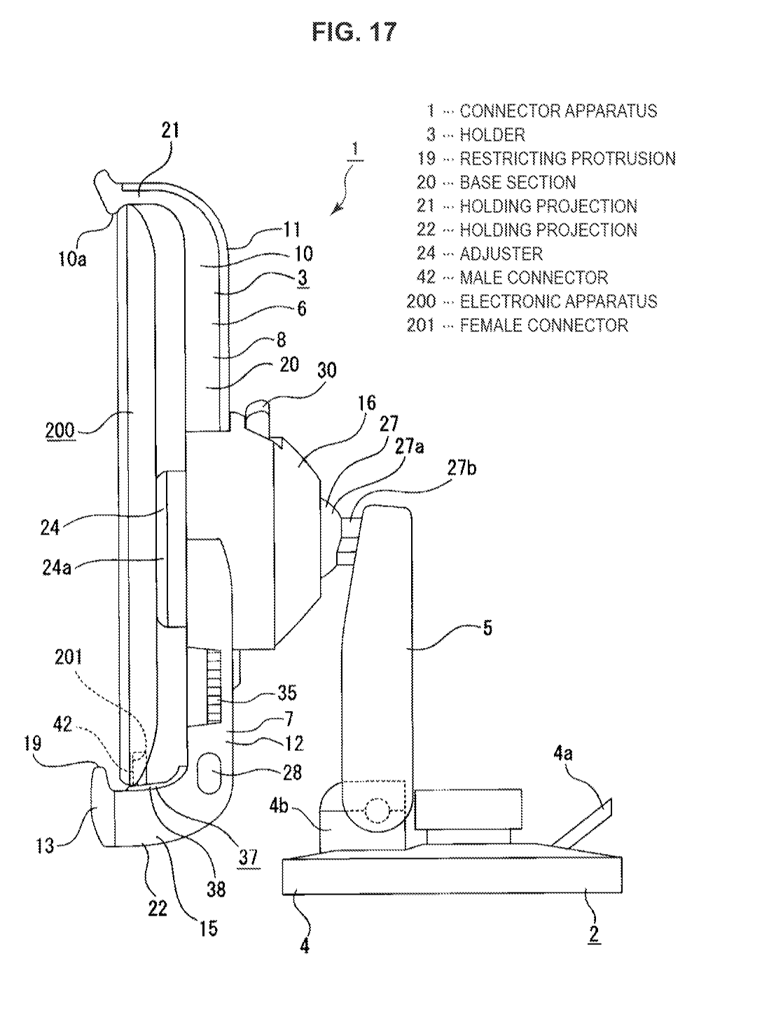

Comparing to the state the electronic apparatus 100 is connected to the connector apparatus 1 (refer to FIG. 16), in the state the electronic apparatus 200 is connected to the connector apparatus 1, the adjuster 24 shifted forward in proportion to the thinner thickness of the electronic apparatus 200 to a different contact position different from the case of the electronic apparatus 100. The adjuster 24 is brought into close contact with the rear face of the electronic apparatus 200 due to a force given by the compression coil spring 23 (refer to FIG. 17).

Therefore, even when either of the electronic apparatus 100 and the electronic apparatus 200 which are different from each other in thickness only is connected to the connector apparatus 1, the positions of the electronic apparatus 100 and the electronic apparatus 200 with respect to the holder 3 are almost the same. Regardless of the difference in thickness, any of the electronic apparatuses 100 and 200 can be properly connected to the connector apparatus 1 and taken-out therefrom.

The maximum rotatable angle of the male connector 42 with respect to the initial position is adapted to 25° with respect to the extending direction H of the base section 20 as described above. However, in the state the forward inclination of the electronic apparatus 200 is restricted by the restricting protrusion 19, the rotation angle of the male connector 42 with respect to the initial position is adapted to be smaller than the maximum angle; for example, to 24°.

Thus, in the connector apparatus 1, in the state the electronic apparatus 200 is brought into contact with the restricting protrusion 19 and the forward inclination thereof is restricted, the rotation angle of the male connector 42 is adapted to be smaller than the maximum rotatable angle of the male connector 42.

Therefore, breakage or operation failure of the rotation mechanism including the rotatable member 37 and the male connector 42 can be prevented.

### [Positional Relationship Between Restricting Protrusion and Male Connector]

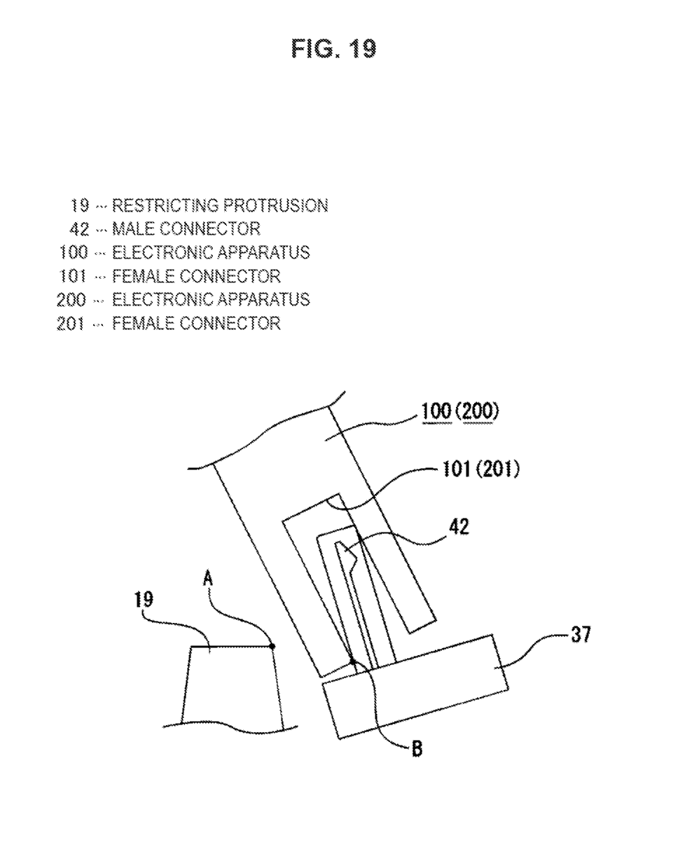

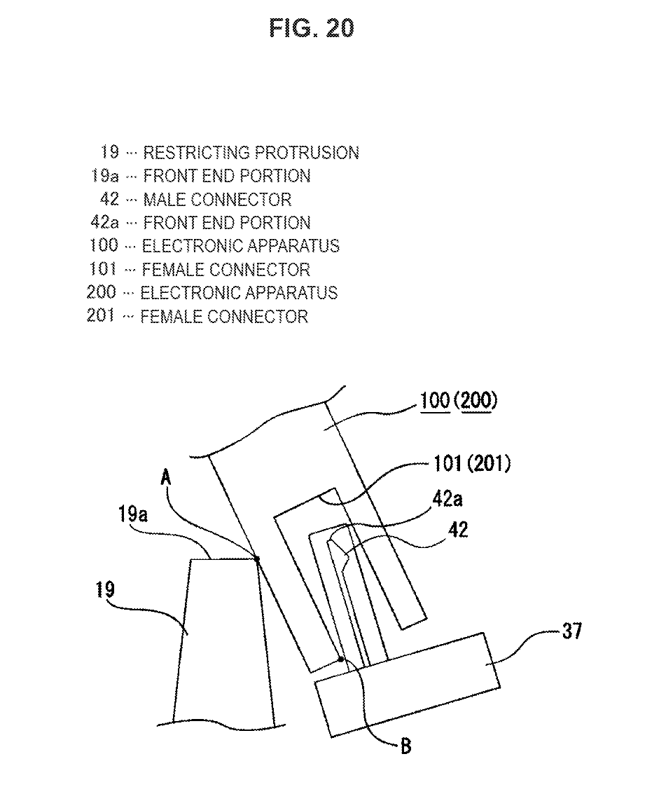

The positional relationship between the restricting protrusion 19 and the male connector 42 will be described below (refer to FIG. 19 and FIG. 20).

Between the female connector 101 (201) and the male connector 42 of the electronic apparatus 100 (200), a gap is given for allowing the male connector 42 to be smoothly inserted into the female connector 101 (201).

In the case the height of the restricting protrusion 19 is smaller than that of the male connector 42 (refer to FIG. 19), when the electronic apparatus 100 (200) is inclined with respect to the male connector 42, the distance from a contact point A between the electronic apparatus 100 (200) and the restricting protrusion 19 to a contact point B between a lower portion of the female connector 101 (201) and a lower portion of the male connector 42 is small. Accordingly, the inclination of the electronic apparatus 100 (200) with respect to the male connector 42 tends to be larger. Accordingly, an upper end C of the male connector 42 tends to come into contact with the female connector 101 (201), the male connector 42 may be subjected to a load applied by the electronic apparatus 100 (200), and the male connector 42 may be easily deformed.

Contrarily, in the case the height of the restricting protrusion 19 is higher with respect to that of the male connector 42 (refer to FIG. 20), when the electronic apparatus 100 (200) is inclined with respect to the male connector 42, the distance from a contact point A between the electronic apparatus 100 (200) and the restricting protrusion 19 to a contact point B between a lower portion of the female connector 101 (201) and a lower portion of the male connector 42 is large. Accordingly, the inclination of the electronic apparatus 100 (200) with respect to the male connector 42 is prevented from getting too large; and thus, an upper end C of the male connector 42 rarely comes into contact with the female connector 101 (201). Since little load is applied to the male connector 42 by the electronic apparatus 100 (200); and thus, the male connector 42 is rarely deformed.

Therefore, in the connector apparatus 1, in order to ensure a large distance from the contact point A to the contact point B, in the state electronic apparatus 100 (200) with the female connector 101 (201) connected to the male connector 42 is brought into contact with the restricting protrusion 19, the front end portion (upper end portion) 19a of the restricting protrusion 19 and the front end portion (upper end portion) 42a of the male connector 42 are adapted to be at generally the same position in a vertical direction.

Therefore, when the electronic apparatus 100 (200) is inclined with respect to the male connector 42, the inclination of the electronic apparatus 100 (200) with respect to the male connector 42 is prevented from getting too large, and thus the male connector 42 is rarely deformed.

### CONCLUSION

As described above, in the connector apparatus 1, the male connector 42 is configured to be rotatable, and the restricting protrusion 19 facing to the male connector 42 is formed in the front end portion of the holding projection 22 in front of the male connector 42. When the electronic apparatus 100 (200) is inclined with respect to the holder 3 and the male connector 42 is rotated, the electronic apparatus 100 (200) is brought into contact with the restricting protrusion 19 to restrict the male connector 42 not rotate exceeding a predetermined angle.

Accordingly, since little load is applied to the male connector 42 by the electronic apparatus 100 (200) and the male connector 42 is rarely deformed, the male connector 42 can be prevented from being deformed while the electronic apparatus 100 (200) is being taken out from the connector apparatus 1.

Additionally, the present technology may also be configured as below.

(1) A connector apparatus, including:

a holder that holds an electronic apparatus having a female connector; and

a male connector to be inserted into the female connector to connect thereto when the electronic apparatus is held by the holder,

wherein the holder includes a base section and a pair of holding projections each protruding in a generally same direction from both ends of the base section, the pair of holding projections engages with the electronic apparatus at both end portions to grip the electronic apparatus,

wherein the male connector is rotatably supported by one of the holding projections on an axis which extends in a direction perpendicular to an alignment direction of the pair of holding projections as well as perpendicular to a protruding direction of the holding projections from the base section,

wherein a restricting protrusion is formed at a front end portion of the one of the holding projections facing to the male connector in the protruding direction of the holding projection from the base section, and

wherein, when the engagement of the electronic apparatus with the other holding projection is released in a state the male connector is connected to the female connector and when the male connector is rotated along with the electronic apparatus being inclined with respect to the holder, the electronic apparatus is brought into contact with the restricting protrusion to restrict a rotational movement of the male connector exceeding a predetermined angle.

(2) The connector apparatus according to (1),

wherein, in a state where the electronic apparatus with the female connector being connected to the male connector is brought into contact with the restricting protrusion, a front end portion of the restricting protrusion and a front end portion of the male connector exist at generally a same position in the alignment direction.

(3) The connector apparatus according to (1) or (2),

wherein the male connector is rotatable with respect to the holder within a predetermined angle range, and

wherein a rotation angle of the male connector when the electronic apparatus is brought into contact with the restricting protrusion is adapted to be smaller than a maximum angle within the angle range.

(4) The connector apparatus according to any one of (1) to (3),

wherein, in a state before the electronic apparatus is held by the holder, the male connector is inclined toward the restricting protrusion with respect to the alignment direction of the pair of holding projections.

(5) The connector apparatus according to (4),

wherein a position of the male connector in a state before the electronic apparatus is held by the holder is set as an initial position,

wherein the male connector is configured to be rotatable in an opposite direction with respect to the initial position, and

wherein the male connector includes a bias spring for biasing the male connector toward the initial position.

(6) The connector apparatus according to any one of (1) to (5),

wherein the base section of the holder includes an adjuster movable in the protruding direction of the holding projections from the base section, which is configured to be pressed against the electronic apparatus when the electronic apparatus is held by the holder,

wherein the holder is capable of holding an electronic apparatus having a different size in the protruding direction of the holding projections from the base section, and

wherein, in a state the electronic apparatus is held by the holder, a contact position of the adjuster with respect to the electronic apparatus can be changed in accordance with the size of the held electronic apparatus.

Particular configuration and structure of the parts of the preferred embodiment according to the present technology are given as an example of implementation only of the present technology. Accordingly, technical range of the present technology should not be interpreted determinately for the reason of these descriptions.

The present disclosure contains subject matter related to that disclosed in Japanese Priority Patent Application JP 2011-156632 filed in the Japan Patent Office on Jul. 15, 2011, the entire content of which is hereby incorporated by reference.

What is claimed is:

1. A connector apparatus, comprising:
a holder that holds an electronic apparatus having a female connector; and
a male connector to be inserted into the female connector to connect thereto when the electronic apparatus is held by the holder,
wherein the holder includes a base section and a pair of holding projections each protruding in a generally same direction from both ends of the base section, the pair of holding projections engages with the electronic apparatus at both end portions to grip the electronic apparatus,
wherein the male connector is rotatably supported by one of the holding projections on an axis which extends in a direction perpendicular to an alignment direction of the pair of holding projections as well as perpendicular to a protruding direction of the holding projections from the base section,
wherein a restricting protrusion is formed at a front end portion of the one of the holding projections facing to the male connector in the protruding direction of the holding projection from the base section, and
wherein, when the engagement of the electronic apparatus with the other holding projection is released in a state the male connector is connected to the female connector and when the male connector is rotated along with the electronic apparatus being inclined with respect to the holder, the electronic apparatus is brought into contact with the restricting protrusion to restrict a rotational movement of the male connector exceeding a predetermined angle.

2. The connector apparatus according to claim 1,
wherein, in a state where the electronic apparatus with the female connector being connected to the male connector is brought into contact with the restricting protrusion, a front end portion of the restricting protrusion and a front end portion of the male connector exist at generally a same position in the alignment direction.

3. The connector apparatus according to claim 1,
wherein the male connector is rotatable with respect to the holder within a predetermined angle range, and
wherein a rotation angle of the male connector when the electronic apparatus is brought into contact with the restricting protrusion is adapted to be smaller than a maximum angle within the angle range.

4. The connector apparatus according to claim 1,
wherein, in a state before the electronic apparatus is held by the holder, the male connector is inclined toward the restricting protrusion with respect to the alignment direction of the pair of holding projections.

5. The connector apparatus according to claim 4,
wherein a position of the male connector in a state before the electronic apparatus is held by the holder is set as an initial position,
wherein the male connector is configured to be rotatable in an opposite direction with respect to the initial position, and
wherein the male connector includes a bias spring for biasing the male connector toward the initial position.

6. The connector apparatus according to claim 1,
wherein the base section of the holder includes an adjuster movable in the protruding direction of the holding projections from the base section, which is configured to be pressed against the electronic apparatus when the electronic apparatus is held by the holder,
wherein the holder is capable of holding an electronic apparatus having a different size in the protruding direction of the holding projections from the base section, and
wherein, in a state the electronic apparatus is held by the holder, a contact position of the adjuster with respect to the electronic apparatus can be changed in accordance with the size of the held electronic apparatus.
